(19) United States
(12) Patent Application Publication
(10) Pub. No.: US 2012/0301225 A1
(43) Pub. Date: Nov. 29, 2012

(54) Offshore Coiled Tubing Deployment Vessel

(76) Inventor: Keith K. Millheim, The Woodlands, TX (US)

(21) Appl. No.: 13/568,716

(22) Filed: Aug. 7, 2012

Related U.S. Application Data
(63) Continuation of application No. 13/087,093, filed on Apr. 14, 2011, now abandoned.
Application No. 13/087,093 is a continuation of application No. 12/275,069, filed on Nov. 20, 2008, now abandoned.
(60) Provisional application No. 61/003,832, filed on Nov. 20, 2007.

(51) Int. Cl. F16L 1/12

(52) U.S. Cl. 405/166

(57) ABSTRACT

An offshore coiled tubing deployment system is provided, wherein the system includes a sea vessel hull configured to include a mounted coiled tubing spool; and a mast configured to guide lengths of coiled tubing received from said mounted coiled tubing spool. Methods, means and locations for the mounted coiled tubing spool are also provided, as well as lubricated coiled tubing riser assemblies which interface with self-standing riser systems. Tractors, swivel plates, buoyancy devices and positioning systems therefor; and a self-standing riser system joined with one or more of a blowout preventer, wellhead, production tree or injection tree are also disclosed.

### CROSS REFERENCE TO RELATED APPLICATIONS

The instant application is a continuation of U.S. Non-Provisional application Ser. No. 13/087,093 filed Apr. 14, 2011, still pending, which is a continuation of U.S. Non-Provisional application Ser. No. 12/275,069 filed Nov. 20, 2008, now abandoned, which claims the benefit of prior U.S. Provisional Application No. 61/003,832, filed Nov. 20, 2007.

### FIELD OF THE INVENTION

The present invention relates generally to coiled tubing units used during oil and gas exploration and production, and in a particular though non-limiting embodiment, to a coiled tubing deployment vessel designed for use in various offshore environments.

### BACKGROUND OF THE INVENTION

Deep water drilling of oil and gas injection wells has become increasingly popular over the past 20 years. A large percentage of subsea wells have been equipped with either production or injection trees, which are often referred to as “Christmas Trees.” Typical injection wells have injection lines that transmit oil, gas, water and other fluids into a central gathering location, and then subsequently toward shore or a production facility on the water surface. An advantage of utilizing a subsea injection well is that it can be positioned far away from a central production facility while maintaining ongoing operations. However, one of the disadvantages of using a subsea injection well with a production tree involves the well's restoration capabilities.

When a subsea well malfunctions in such a manner that production or fluid injection is hindered, it is typically necessary to perform a well intervention. In most circumstances, the subsea well will need to be shut in, resulting in production loss and the inability to continue fluid injection.

The most common method of performing an intervention (also called “workover”) currently involves the positioning of a Mobile Offshore Drilling Unit (hereinafter “MODU”) over the well, and performance of the various testing and maintenance activities required to restore the well's functionality. However, since MODUs are predominately used for drilling and completion activities, they are often unavailable or ill-equipped to handle intervention tasks. Furthermore, intervention operations tend to cost approximately the same amount per day as a MODU rental rate for drilling and completion functions, making each intervention expensive. Moreover, deck space limitations on MODUs have inhibited the use of coiled tubing units in deepwater operations. Furthermore, the excessive weight associated with coiled tubing spools often exceeds the lifting capacity of the typical crane affixed to a MODU.

There is, therefore, a need for a vessel capable of accommodating a large reel or several reels of coiled tubing, with the capacity to safely transport and deploy the tubing to a well in need of intervention.

### SUMMARY OF THE INVENTION

An offshore coiled tubing deployment system is provided, wherein the system includes a sea vessel hull configured to include a mounted coiled tubing spool; and a mast configured to guide lengths of coiled tubing received from said mounted coiled tubing spool. Methods, means and locations for the mounted coiled tubing spool are also provided, as well as lubricated coiled tubing riser assemblies which interface with self-standing riser systems. Tractors, swivel plates, buoyancy devices and positioning systems therefor; and a self-standing riser system joined with one or more of a blowout preventer, wellhead, production tree or injection tree are also disclosed.

### BRIEF DESCRIPTION OF THE DRAWINGS

FIG. 1 is a schematic diagram of a coiled tubing deployment vessel comprising a plurality of known subsea oil and gas drilling, exploration and production equipment, according to example embodiments.

FIG. 2 is a schematic diagram of a coiled tubing deployment vessel and an enhanced view of a coiled tubing riser assembly, according to example embodiments.

FIG. 3 is a schematic diagram of a coiled tubing deployment vessel leaving the deployment radius while remaining attached to the well, according to example embodiments.

### DETAILED DESCRIPTION

The description that follows includes exemplary systems, methods, and techniques that embody various aspects of the presently inventive subject matter. However, it will be readily understood by those of ordinary skill in the art that the described embodiments may be practiced without one or more of these specific details. In other instances, well-known manufacturing equipment, protocols, structures and techniques have not been shown in detail in order to avoid obfuscation in the description.

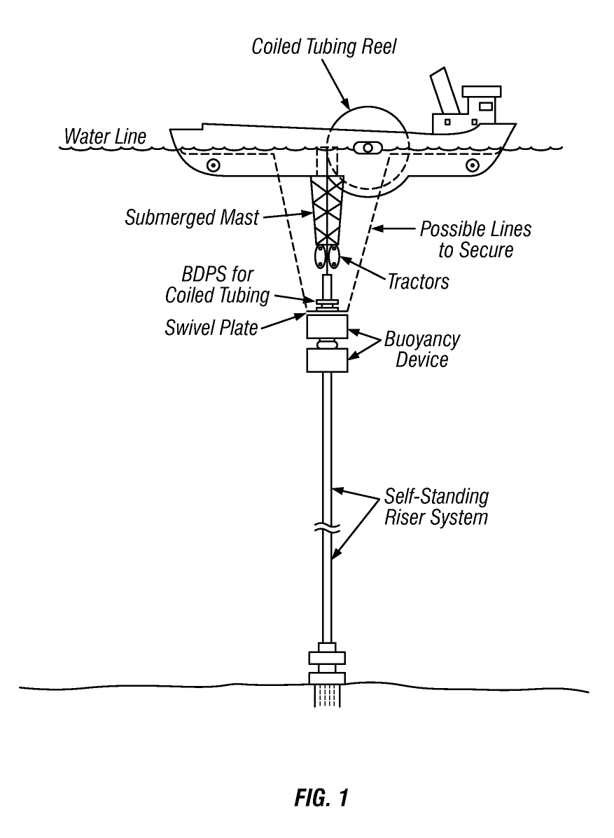

Referring now to the example embodiment depicted in FIG. 1, a coiled tubing deployment vessel is illustrated, comprising a submerged mast and a mounted coiled tubing reel. Embodiments of the coiled tubing deployment vessel can include adapted lengths and segments of vessels typical of exploration and production sea vessels, such as workboats, anchor handling boats, etc. A significant advantage of the invention is that a wide variety of existing or custom fit vessels can be used, with the only firm requirement being that they are capable of providing the support required for the coiled tubing based intervention work disclosed herein. According to one example embodiment, the deployment vessel comprises a combination of different types of vessels, such as a work boat brought into structurally integral mechanical communication with an anchor handling boat.

In some embodiments, the coiled tubing reel is mounted near a center area of the coiled tubing deployment vessel in order to accommodate the great weight associated with coiled tubing reels, and to help maintain balance and equilibrium across the vessel. The centermost area is also generally the most stable, due to its increased resistance to wind, currents, wave forces, etc.

In the embodiment depicted in FIG. 1, the coiled tubing reel is also disposed in a recessed area formed by cutting through the deck and allowing the bottom of the reel to extend into the hull storage space typically enclosed below deck. Alternatively, the recess can be formed from a void space cut through the deck and hull of the vessel, thereby allowing the coiled tubing deployment vessel to utilize even the largest of known coiled tubing reels. Disposing the reel in a recess or void space improves the overall balance of the system, and lowers the effective center of gravity of the vessel, each of which help to maintain stability and control.

In still further embodiments, an extension can be constructed below the normal hull keel in order to properly accommodate very large reels of tubing. Those of ordinary skill in the art will appreciate that a modified coiled tubing deployment vessel could, if properly configured, accommodate reels comprising more than 50,000 ft. of coiled tubing.

In various other example embodiments, the center of the tubing reel is affixed near the deck level of the deployment vessel, thereby admitting to simple installation of the reel by large cranes or the like. In other embodiments, the center portion of the tubing reel comprises support and bearing fixtures that extend horizontally across the deck level of the deployment vessel. In preferred embodiments, the support and bearing fixtures are laterally adjustable, and admit to installation of both larger and smaller reels of tubing.

Further example embodiments employ one or more submerged masts used to guide, push, pull, etc., desired lengths of coiled tubing as it is unwound and passed into and through the well. In a presently contemplated embodiment, the structural configuration of the mast is similar to a commonly known drilling mast, albeit disposed on the underside of the ship in contravention to the typical drilling mast.

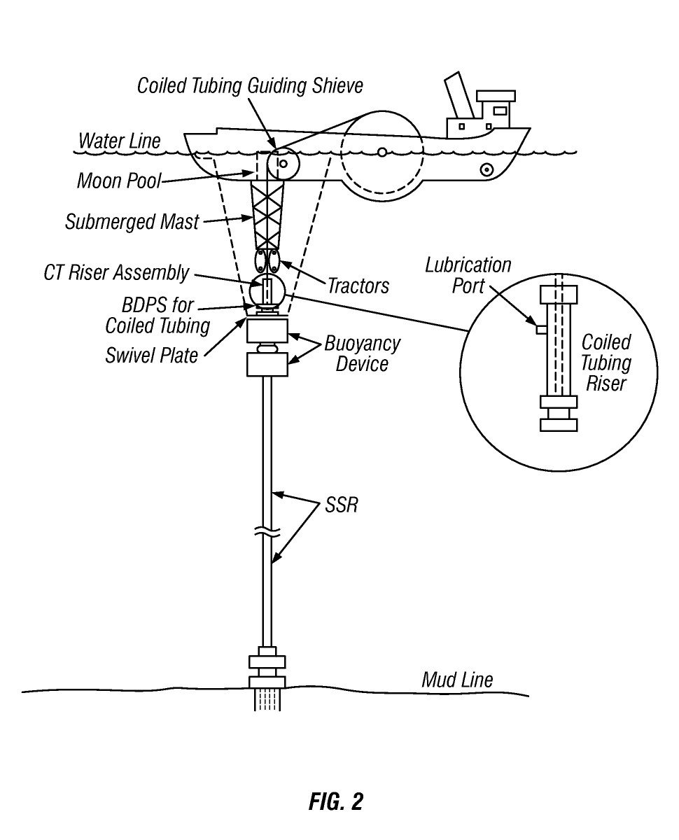

In the embodiment depicted in FIG. 1, the mast is submerged through a moon pool and affixed to the hull of the deployment vessel. In alternative embodiments, the mast and moon pool are positioned near the aft end of the vessel, though ballast or other weight-bearing loads may be required in other portions of the vessel to offset the great weight of the coiled tubing reel. FIG. 2, for example, depicts an embodiment of the deployment vessel wherein the mast is submersed through a moon pool positioned near the vessel's stern, and the primary coiled tubing reel spools lengths of tubing to a smaller, subordinate reel disposed above the mast rather than directly to the mast itself.

According to some embodiments, tractors or other toothed devices are disposed in mechanical communication with the mast and utilized to assist with the unreeling or transverse reeling operations required during well intervention. In some embodiments, the tractors grab and pull coiled tubing unreeled from above, and feed the tubing into a specially designed coiled tubing riser assembly, which in further embodiments is either self-lubricating or includes a port for injecting lubricant into the assembly.

Example embodiments of the coiled tubing riser assembly can comprise a wide variety of known materials (e.g., plastic, rubber or metal materials), but should in any event be capable of assisting in the guidance and control of tubing during the workover. In further embodiments, the coiled tubing riser assembly is disposed in mechanical communication with other common exploration and production components, such as buoyancy devices, swivel plates, pressure plates, blowout preventers, etc.

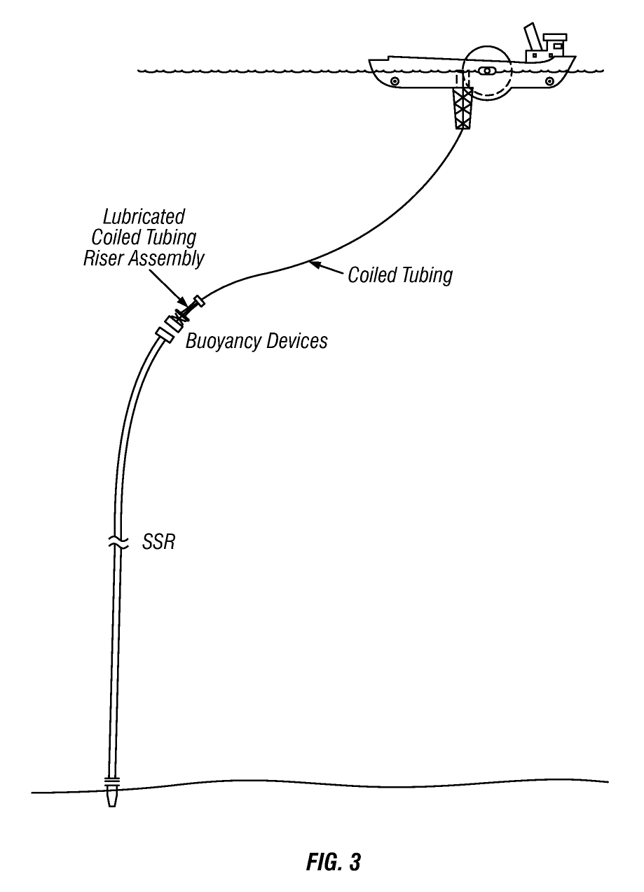

In still further embodiments, the coiled tubing riser assembly 19 is disposed in direct communication with a self-standing riser assembly, as illustrated in FIG. 3. In one particular embodiment, the lower portion of the coiled tubing riser assembly is disposed in mechanical communication with a blowout preventer, thereby lessening back-ups, exposure to excessive pressures, etc.

In the example embodiments depicted in FIGS. 1 and 2, the self standing riser assembly is disposed in communication with a subsea production or injection tree installed on the wellhead near the mud-line. In the depicted embodiments, the riser system is also disposed in communication with one or more buoyancy chambers, which can be used to stiffen the string and allow the coiled tubing to pass through the riser more easily.

In one embodiment, the coiled tubing deployment vessel is positioned directly over or in the proximate vicinity of the coiled tubing riser assembly and attendant self-standing riser system, as illustrated in FIGS. 1 and 2. Other embodiments might utilize dynamic positioning equipment, such as thrusters, propellers, spars, etc., to align the vessel and improve the functionality of the system. Still further embodiments comprise a specially designed swivel turret or the like, so that various components of the system can be aligned more easily. In some embodiments, such alignments are further facilitated by support members, such as cables, rope, chains, winch lines, etc.

The embodiments depicted in FIGS. 1 and 2 further demonstrate a system wherein coiled tubing is safely deployed into a subsea well requiring intervention, early testing, etc. via a coiled tubing deployment vessel. In various embodiments, the coiled tubing is unspooled from the tubing reel, and then reeved through a moon pool or another structural aperture. The coiled tubing is then guided by the mast and attached to a tractor, which grabs the tubing and feeds it into a coiled tubing riser assembly, where in some embodiments it is lubricated prior to introduction into the self-standing riser assembly and, ultimately, into the well.

In some embodiments, the coiled tubing is deployed until the tractor can securely fasten onto a significant portion thereof, or alternatively after the tubing has been introduced into the well, and the vessel is then moved out of the deployment radius while the tubing remains attached to the well, as illustrated in FIG. 3. In this manner, additional lengths of tubing can be deployed for cases where the well itself is very deep and additional amounts of tubing are required to complete the workover.

In some embodiments, the mast is designed to adjust to such an event by tilting in a direction that accommodates the unwinding of the coiled tubing while moving away from the riser assembly. Conversely, the vessel can return to the deployment radius while simultaneously spooling in the coiled tubing and repositioning over the well. If need be, the coiled tubing can be crimped, sheared, etc., in a manner that restricts fluid from escaping in the event the vessel detaches from the coiled tubing altogether.

The foregoing specification is provided for illustrative purposes only, and is not intended to describe all possible aspects of the present invention. Moreover, while the invention has been shown and described in detail with respect to several exemplary embodiments, those of ordinary skill in the art will appreciate that minor changes to the description, and various other modifications, omissions and additions may also be made without departing from the spirit or scope thereof.

1. An offshore coiled tubing deployment system, said system comprising:
a sea vessel hull configured to include a mounted coiled tubing spool; and
a mast configured to guide lengths of coiled tubing received from said mounted coiled tubing spool.

2. The offshore coiled tubing deployment system of claim 1, wherein a central axis portion of said coiled tubing spool is mounted near a deck surface of said vessel, so that a bottom portion of said spool extends down into a recess in the hull storage space below deck.

3. The offshore coiled tubing deployment system of claim 1, wherein said mounted coiled tubing spool is disposed in a recess formed from a void space cut through a deck surface and a hull surface.

4. The offshore coiled tubing deployment system of claim 1, wherein said mounted coiled tubing spool is disposed in a recess formed from a void space cut in a deck surface and a hull extension member formed below the vessel's hull keel.

5. The offshore coiled tubing deployment system of claim 1, wherein said mounted coiled tubing spool further comprises a variable bearing and support structure, so that coiled tubing spools of differing sizes are accommodated.

6. The offshore coiled tubing deployment system of claim 1, further comprising a coiled tubing riser assembly.

7. The offshore coiled tubing deployment system of claim 6, wherein said coiled tubing riser assembly is self-lubricated.

8. The offshore coiled tubing deployment system of claim 6, wherein said coiled tubing riser assembly further comprises a port for injecting lubricant into said riser assembly.

9. The offshore coiled tubing deployment system of claim 1, further comprising one or more of a tractor, a swivel plate, a buoyancy device, a buoyancy device positioning system, and a self-standing riser system.

10. The offshore coiled tubing deployment system of claim 9, wherein said self-standing riser system is disposed in mechanical communication with one or more of a blowout preventer, a wellhead, a production tree and an injection tree.
